(19) United States
(12) Patent Application Publication
(10) Pub. No.: US 2011/0246439 A1
(43) Pub. Date: Oct. 6, 2011

(54) AUGMENTED QUERY SEARCH

(75) Inventors: Michael A. Isard, San Francisco, CA (US); Marc A. Najork, Palo Alto, CA (US); Sean A. Suchter, Los Altos Hills, CA (US); Eric R. Scheel, Sunnyvale, CA (US)

(73) Assignee: Microsoft Corporation, Redmond, WA (US)

(21) Appl. No.: 12/754,614

(22) Filed: Apr. 6, 2010

(51) Int. Cl. G06F 17/30; G06F 21/00

(52) U.S. Cl. 707/706; 707/723; 726/3; 707/E17.002; 707/E17.014; 707/E17.008

(57) ABSTRACT

A query is annotated with a small sketch (e.g. a Bloom filter) that approximates a set of interest that is related to the query. The query and sketch may be forwarded to index servers that each stores a portion of a search engine corpus. Each of the index servers may filter documents using the sketch before returning results for aggregation. The sketch is designed so there may be false positives (results returned by authors not in the set), but no false negatives (all relevant results are returned). The final aggregated results set may be checked against the full set to remove false positives before returning the final results to the user.

### BACKGROUND

Search engines typically are the starting point from which users begin their browsing for information. In the case of social networks, a user may want to search for documents generated by a particular author or authors within a group having a social relationship. The user may desire that the search engine restrict query results to documents generated by those within the social network. However, the group may be an ever-evolving set of individuals participating on many social networking sites.

Providing a restricted set of search results can be challenging for search engines. Typically, a search index is too large of a corpus to be stored on a single index server and is split up on several index servers. When users issue a search query against the corpus, a front end of the search engine receives the query and sends it to each of the index servers on which the portions of the search index are hosted. Each index server returns documents that are responsive to the query. The front end then aggregates and ranks the responses from each of the index servers to return a predetermined number of the results to the user. This process can be computationally expensive and difficult for queries against information that is not pre-indexed by the search engine, such as a user's social network.

### SUMMARY

In general, one aspect of the subject matter can be implemented in a method for annotating a query with a small sketch (e.g. a Bloom filter) that approximates a set of interest that is related to the query. The query and sketch may be forwarded to index servers that each stores a portion of a search engine corpus. Each of the index servers may filter documents using the sketch before returning results for aggregation. The sketch is designed so there may be false positives (results returned by authors not in the set), but no false negatives (all relevant results are returned). The final aggregated results set may be checked against the full set to remove false positives before returning a final set of search results to the user.

In accordance with some implementations, there is provided a method that may include receiving a query associated with a set of interest at a search engine, determining a filter representation of the set, and sending the filter and the query to index servers that each store a portion of a search engine corpus. Each of the index servers may apply the filter to query results, which may then be aggregated by, e.g., a front end server of the search engine.

In accordance with other implementations, a method may include storing documents of a set of members in respective databases of index servers of a search engine. A per-index server filter of the set may be determined that approximates the set of members having documents stored on a respective index server. The per-index server filter and the query may be sent to the respective index server and applied to filter the query results determined by the respective index server. The results of each of the index servers may then be aggregated.

In accordance with some implementations, there is provided a method that may include receiving a query at a search engine that may be associated with a set of document authors, and determining a representation of the set of document authors. The query may be augmented with the representation to create a hybrid query that is communicated to distributed index servers, and applied against a database of each of the distributed index servers to determine per-index server results. The per-index server results may be aggregated to create aggregated results.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 is a block diagram of an example online environment;

FIG. 2 illustrates an operational flow of an implementation of a method for receiving a query, determining a set, and returning results to the query;

FIG. 3 illustrates an operational flow of another implementation of a method for receiving a query, determining a set, and returning results to the query; and

FIG. 4 shows an exemplary computing environment.

### DETAILED DESCRIPTION

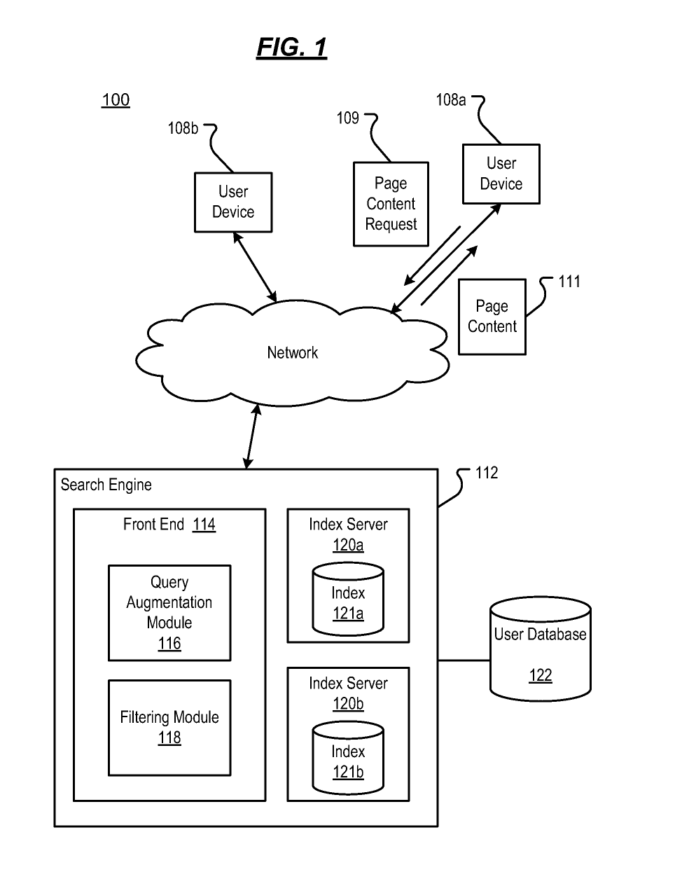

FIG. 1 is a block diagram of an example online environment 100. The online environment 100 may facilitate the identification and serving of content items, e.g., web pages, advertisements, etc., to users. A computer network 110, such as a local area network (LAN), wide area network (WAN), the Internet, or a combination thereof, connects user devices 108a and 108b and a search engine 112. The search engine 112 may include a front end 114, a query augmentation module 116, a filtering module 118, index servers 120a and 120b, indexes 121a and 121b, and a user database 122. Although only two user devices (108a and 108b), two index servers (120a and 120b), and two indexes 121a and 121b are shown, the online environment 100 may include many user devices, index servers and indexes.

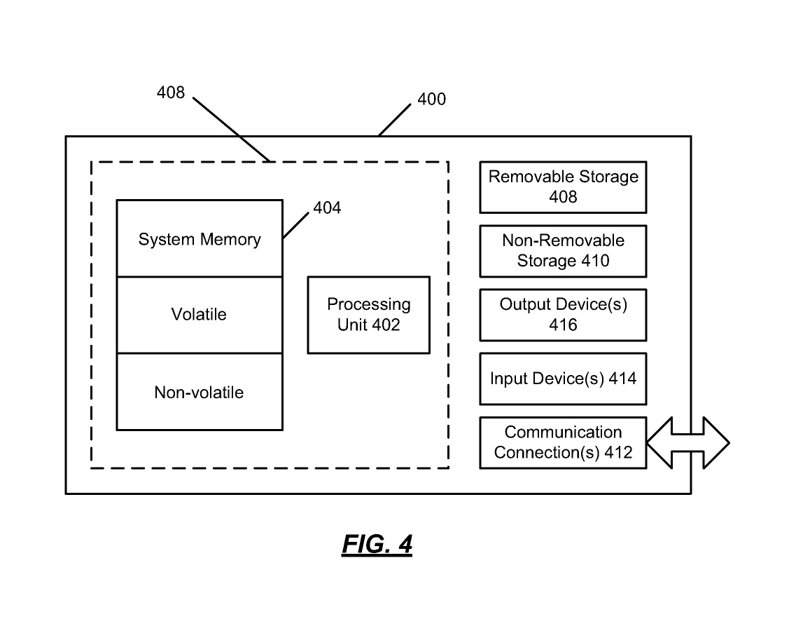

A user device, such as user device 108a, may submit a page content request 109 to the search engine 112 using a web browser application running on the user device 108a. In some implementations, the page content 111 may be provided to a web browser running on the user device 108a in response to the request 109. The page content 111 may include search results, advertisements, or other content placed on the page content 111 by the search engine 112. Example user devices include personal computers (PCs), mobile communication devices, television set-top boxes, etc. An example user device is described in more detail below with reference to FIG. 4.

In accordance with implementations herein, a user of the user device 108a may authenticate with the search engine 112 or other authentication source (e.g., a single sign-on service) associated with the search engine 112. Authentication information may be stored in the user database 122. Thus, upon authentication, the search engine 112 knows the identity of the query-submitting user at the user device 108a when the query is received by the search engine 112. With the authenticated user's information in the user database 122, the search engine 112 may derive information about the user's relationships with others, and in particular, those who may be associated with the user's social network and may have authored documents related to the submitted query.

The front end 114 may be a computing device, such as that described with respect to FIG. 4 that receives queries from the user devices 108a or 108b. The front end 114 may pre-process queries and/or post-process results from/to the user devices 108a and 108b. For example, the front end 114 may package a query for transmission to the index servers 120a and 120b. The front end 114 may also aggregate and rank results from the index servers 120a and 120b to communicate search results to the user device 108a or 108b.

The query augmentation module 116 may determine a sketch or data structure representation of a complete set of interest that is used to augment a user query to filter the results determined by the index servers 120a and 120b. For example, a Bloom filter may be constructed as the data structure, where the Bloom filter approximates the complete set of interest. A Bloom filter is a space efficient probabilistic data structure that can be used to test the membership of an element in a given set; the test may yield a false positive, but never a false negative. A Bloom filter represents a set using an array A of m bits (where A[i] denotes the ith bit), and uses k hash functions h₁ to hₖ to manipulate the array, each hᵢ mapping some element of the set to a value in [1,m]. To add an element e to the set, A[hᵢ(e)] is set to 1 for each 1≦i≦k. To test whether e is in the set, it is verified that A[hᵢ(e)] is 1 for all 1≦i≦k. Given a Bloom filter size m and a set size n, the optimal (false-positive minimizing) number of hash functions

$$k is \frac{m}{n} ln 2.$$

the probability of false positives is

$${( \frac{1}{2} )}^{k} .$$

Thus, if a user submits a query where the desired results are to be those documents authored by friends within a social network or group, the complete set may be authors or friends of interest within the user's social network. The Bloom filter approximates the complete set by providing a data structure that approximates the following relationship, “if x is not my friend, then x is probably not part of the set,” and if “x is my friend, then x is part of the set.” Alternatively or additionally, the filter may be any probabilistic data structure (e.g., a hash-based technique or other compact representation of a complete set) that is used to determine set membership and that may allow for false positives in the set, but not false negatives.

The query augmentation module 116 augments the user query with the data structure and communicates the user query and the data structure as a hybrid query to one or more index servers 120a and 120b. Thus, instead of issuing a strict BOOLEAN query (e.g., including a disjunction listing the set of authors that may be returned by the query), the hybrid query is constructed where the set is represented as a bounded-size approximation that may be efficiently checked by the index servers 120a and 120b. This allows very large sets to be checked efficiently without undue network traffic or computational expense.

The index servers 120a and 120b may contain a distributed portion of the corpus of the search engine 112 within a respective index 121a or 121b, and each may identify results to the user query from its portion of the corpus by applying the data structure and the hybrid query to its portion of the corpus. The indexes 121a and 121b may be, e.g., a database management system. The results the index servers 120a and 120b may be returned to the front end 114 for aggregation and/or ranking.

The filtering module 118 may eliminate false positives in the aggregated result set. As noted above, the data structure may be defined such that false positives are present in the results. The filtering module 118, however, may have full knowledge of the complete set. Using the knowledge of the complete set, the filtering module 118 may remove the false positives from the results returned by the index servers 120a and 120b. The filtered aggregated set may be then returned by the front end 114 to the user at the user device 108a or 108b.

In some implementations, a friendship graph may be provided at each of the index servers 120a and 120b. The friendship graph may be a mathematical structure to model pairwise relations between the user and the user's friends from a viewpoint of the social network. The graph may be a type of distributed graph and may comprise a collection of vertices and a collection of edges that connect pairs of vertices to show the associations. If each of the index servers 120a and 120b contains the friendship graph, the front end 114 may augment the query with the user ID to form a hybrid query of the structure “{query} AND user:u”, where u is the user ID. The hybrid query may be communicated to the index servers 120a and 120b, which can then expand the user ID to the set of friends using the friendship graph. This solution may be predicated on the friendship graph being replicated across all index servers 120a and 120b.

In some implementations, the corpus may be partitioned across index servers computers 120a and 120b such that all documents authored by a particular “friend” reside within the index (e.g., 121a) of the same index server (e.g., 120a), and the friendship graph may be partitioned in a similar fashion, such that each of the index servers 120a and 120b has a friendship graph particular for the documents stored thereon. This reduces the amount of traffic on the down-link from the front end 114 to the index servers 120a and 120b and the memory footprint of the friendship graph on each index server.

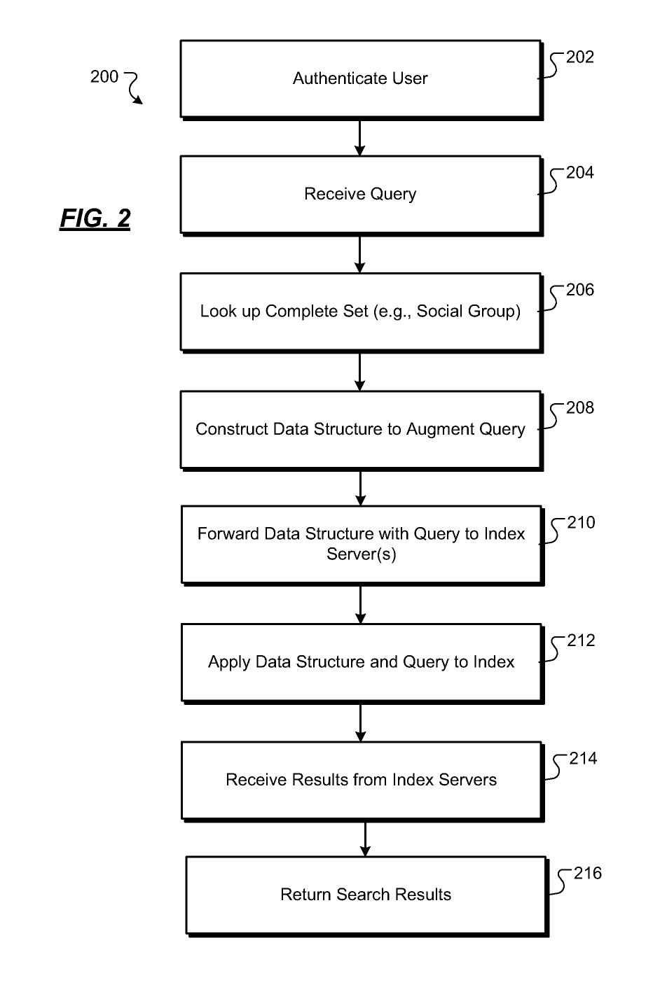

FIG. 2 illustrates an operational flow of an implementation of a method 200 for receiving a query, determining a set, and returning results to the query. At 202, a user is authenticated. The user may be authenticated to the search engine 112 through any authentication mechanism that accesses the user database 122 to confirm the user's identity. At 204, a query is received from the user. The user may submit the query from user device 108a as the page content request 109 to the search engine 112 on, e.g., a webpage presented by the search engine 112.

At 206, a look-up of the complete set of interest associated with the user is performed. For example, the complete set of interest may be a user's social network or group of friends, which may be ascertained from information in the user database 122. One or more of the friends in the authenticated user's social network may be an author of documents of interest, as specified by the query. At 208, a data structure is formed to represent the group of friends that may be used to augment the query. For example, the Bloom filter may be constructed by the query augmentation module 116 to represent the user's complete social network of friends.

At 210, the data structure and query are forwarded to the index servers. The Bloom filter may augment the user's query as a hybrid query to describe an additional criterion of the group of friends to the index servers 120a and 120b. At 212, the data structure and query are applied to the indexes 121a and 121b on each of the index servers 120a and 120b. Applying the Bloom filter to the index will filter the results satisfying the query to the bounded set represented by the Bloom filter.

At 214, the results are returned. The front end 114 may receive the results from each of the index servers 120a and 120b. A post-processing stage may be applied by the filtering module 118 at the front end 114 to remove any false positives, since the filtering module 118 may have access to the complete set (e.g., the complete group of friends/social network) which is not transmitted along with the query to the index servers 120a and 120b. The filtering module 118 may compare the complete set to the results and filter out (i.e., discard) the false positives, as they would not satisfy the complete set.

At 216, the search results are returned to the user. As such, the search results returned by the front end 114 are targeted in that they satisfy the query and are relevant to the user's social context.

In accordance with the above, Bloom filters of different sizes may be communicated to the index servers depending on the size of the filter set. In some instances, the exact (complete) set itself may be communicated for queries where the set is relatively small.

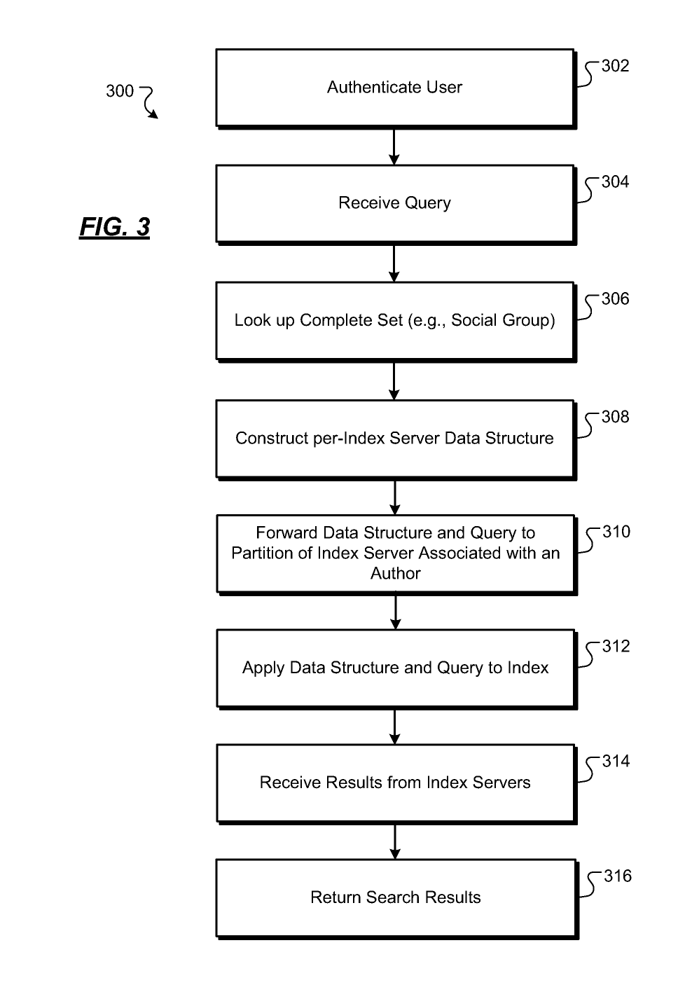

FIG. 3 illustrates an operational flow of another implementation of a method 300 for receiving a query, determining a set, and returning results to the query. In the operational flow of FIG. 3, the corpus may be partitioned across all index serving computers such that all documents authored by a particular author reside on a same index server.

In the flow of FIG. 3, the operations performed at 302-306 may be performed as described above with regard to 202-206 in FIG. 2. At 308, a data structure is formed from the group of friends/social network that may be used to augment the query on a per-index server basis. For example, the query augmentation module 116 may construct a separate Bloom filter for each index server 120a or 120b, containing only the friends of the user whose postings/documents are stored in the index 121a or 121b. As such, the sum of the optimum sizes of the per-index server Bloom filters is the same as the optimum size of the global Bloom filter containing all friends of the user, but may be smaller for any particular index server.

At 310, the data structure and query are forwarded to the index servers. A Bloom filter may augment the user's query as a hybrid query, as noted above. However, this implementation reduces network traffic along the down-link to the index servers 120a and 120b, as the query may be directed to fewer index servers and the Bloom filters may be smaller.

At 312, the data structure and query are applied to the index on each of the index servers 120a and 120b. Applying the Bloom filter to the index will filter the results satisfying the query to the bounded set represented by the Bloom filter. At 314, the results are returned. The filtering module 118 may receive and post-process the results from each of the index servers 120a and 120b, as described at 214. At 316, the search results are returned to the user by, e.g., the front end 114.

In addition to the above, the implementations described herein may be used to specify a query against a large database for any large set using a closed form (i.e., the Bloom filter), where the database is not pre-indexed. For example, in a vehicle database, a user may submit a query to determine a list of vehicles that are reported as stolen. The list of stolen vehicles is likely not pre-indexed in the local authority's database before the query is issued. A compact Bloom filter may be constructed to approximate the set of stolen vehicles in order to return the relevant results from the local authority database.

Additionally or alternatively, a user interface may be provided to present an indication to the user that the particular results on, e.g., the page content 112 are from the user's social network. Documents authored by friends within the user's social network may be highlighted or grouped to identify their origin.

FIG. 4 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers, server computers, handheld or laptop devices, multiprocessor systems, microprocessor-based systems, network personal computers, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 4, an exemplary system for implementing aspects described herein includes a computing device, such as computing device 400. In its most basic configuration, computing device 400 typically includes at least one processing unit 402 and memory 404. Depending on the exact configuration and type of computing device, memory 404 may be volatile (such as random access memory (RAM)), non-volatile (such as read-only memory (ROM), flash memory, etc.), or some combination of the two. This most basic configuration is illustrated in FIG. 4 by dashed line 406.

Computing device 400 may have additional features/functionality. For example, computing device 400 may include additional storage (removable and/or non-removable) including, but not limited to, magnetic or optical disks or tape. Such additional storage is illustrated in FIG. 4 by removable storage 408 and non-removable storage 410.

Computing device 400 typically includes a variety of computer readable media. Computer readable media can be any available media that can be accessed by device 400 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 404, removable storage 408, and non-removable storage 410 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 400. Any such computer storage media may be part of computing device 400.

Computing device 400 may contain communications connection(s) 412 that allow the device to communicate with other devices. Computing device 400 may also have input device(s) 414 such as a keyboard, mouse, pen, voice input device, touch input device, etc. Output device(s) 416 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method, comprising:
receiving a query associated with a set of interest;
determining a data structure representation of the set at a query augmentation module;
sending the data structure and the query to a plurality of index servers that each store a portion of a corpus;
applying the data structure to a plurality of query results determined by each index server; and
aggregating the results of the index servers.

2. The method of claim 1, further comprising:
post-processing the results to eliminate false positives by comparing the set to the results; and
discarding results that do not satisfy the set.

3. The method of claim 2, further comprising:
ranking the post-processed results; and
communicating the ranked results.

4. The method of claim 1, further comprising:
authenticating a user submitting the query; and
performing a look-up at a user database to determine the set of interest.

5. The method of claim 4, wherein the set of interest is the user's social network.

6. The method of claim 4, further comprising communicating the results to the user having an indication that the results belong to the set of interest.

7. The method of claim 1, wherein the data structure is a Bloom filter.

8. The method of claim 7, further comprising communicating Bloom filters of a variable size to the index servers in accordance with a size of the set of interest to be filtered.

9. The method of claim 1, further comprising ranking aggregated results.

10. A computer-implemented method, comprising:
receiving a query associated with a set of interest at a search engine;
storing a plurality of documents of a set of members in respective indexes of index servers;
determining, at a query augmentation module, a per-index server data structure of the set that approximates the set of members having documents stored on a respective index server;
sending the per-index server data structure and the query to the respective index server;
applying the per-index server data structure to the query results determined by the respective index server; and
aggregating the results for each of the index servers at a front end of the search engine.

11. The method of claim 10, further comprising:
eliminating false positives by comparing the set of interest to results; and
discarding results that do not satisfy the set of interest.

12. The method of claim 10, further comprising:
authenticating a user; and
performing a look-up at a user database to determine the set of interest.

13. The method of claim 12, wherein the set is the user's social network.

14. The method of claim 13, further comprising:
communicating the results to the user; and
providing an indication that the results are from the set of interest.

15. The method of claim 10, wherein the per-index server data structure comprises a Bloom filter.

16. A computer-implemented method, comprising:
receiving a query at a search engine, the query being associated with a set of document authors;
determining a representation of the set of document authors at a query augmentation module;
augmenting the query with the representation to create a hybrid query that is communicated to a plurality of distributed index servers;
applying the hybrid query against an index of each of the distributed index servers to determine a plurality of per-index server results; and
aggregating the per-index server results to create a plurality of aggregated results at a front end of the search engine.

17. The method of claim 16, further comprising:
ranking the aggregated per-index server results; and
communicating the ranked results.

18. The method of claim 17, further comprising providing an indication in the ranked results that a result is from the set of document authors.

19. The method of claim 17, further comprising discarding results within the aggregated results that do not satisfy the set of document authors.

20. The method of claim 16, further comprising:
authenticating a user; and
performing a look-up at a user database to determine the set of document authors.
